(19) United States
(12) Patent Application Publication
(10) Pub. No.: US 2006/0214558 A1
(43) Pub. Date: Sep. 28, 2006

(54) Image display device

(76) Inventors: Chikae Kubo, Mobara (JP); Nobuyuki Ushifusa, Yokohama (JP); Nobuhiko Fukuoka, Ebina (JP); Shigeru Matsuyama, Mobara (JP); Hiroshi Kawasaki, Ooamishirasato (JP); Akira Ishii, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/387,909

(22) Filed: Mar. 24, 2006

(30) Foreign Application Priority Data
Mar. 25, 2005 (JP) 2005-087806

(51) Int. Cl. H01J 63/04; H01J 1/62

(52) U.S. Cl. 313/495; 313/499

(57) ABSTRACT

The present invention provides a high-quality image display device which allows scanning line electrodes to exhibit a uniform film thickness and the uniform low resistance over a whole length thereof thus suppressing local resistance irregularities and broken steps of the scanning line electrodes. The present invention provides the stacked structure which is constituted of scanning line lower electrodes which are embedded in grooves formed in a main surface of an insulating substrate which constitutes a first substrate, a first insulating layer, signal line electrodes, a second insulating layer, a third insulating layer, and scanning line upper electrodes. Electron sources are constituted of the signal line electrodes, the second insulating layer and the scanning line upper electrodes.

### BACKGROUND OF THE INVENTION

The present invention relates to a flat-panel-type image display device which displays an image by allowing phosphors to emit light with electrons radiated from a plurality of electron sources which are arranged in a matrix array.

As a device which displays an image using minute and integratable cold cathode electron sources, particularly as a display device which is abbreviated as a thin flat-panel type display device (FPD), there has been known a display device which uses electron sources such as field emission type (FED) electron sources, metal-insulator-metal type (MIM) electron sources, metal-insulator-semiconductor type (MIS) electron sources, surface conductive type electron sources, metal-insulator-semiconductor-metal type electron sources or the like. Here, the explanation is made by taking the MIM electron sources as an example. Further, this type of flat panel image display device is also simply referred to as a panel. As a document which discloses a prior art related to this type of image display device, Japanese Patent laid-open 2004-111053 (patent document 1) can be named.

### BRIEF SUMMARY OF THE INVENTION

The image display device such as an FED includes a large number of signal line electrodes which extend in the first direction and are arranged in parallel in the second direction which intersects the first direction, and a large number of scanning line electrodes which are arranged above the signal line electrodes and intersect the signal line electrodes by way of an insulating layer on a main surface of an insulating substrate, wherein at intersecting portions of the signal line electrodes and the scanning line electrodes, electron sources are formed on the signal line electrodes which are arranged close to the scanning line electrodes in plane. To one scanning line electrode, a large number of electron sources which correspond to a large number of signal line electrodes which intersect the scanning line electrode are connected, and all electron sources which are connected to the same scanning line electrode are simultaneously operated. Accordingly, a large electric current flows in the scanning line electrode. In view of such circumstances, the scanning line electrode is required to exhibit a low resistance.

Particularly, when the panel is large-sized, the number of signal line electrodes which intersect the scanning line electrode is increased and a length of the scanning line electrode is also increased and hence, the remoter from a power supply end, the power for driving the electron source is lowered thus generating brightness irregularities on a display image whereby it is impossible to provide a high quality image display. Accordingly, the lowering of resistance of the scanning line electrode has been one of crucial tasks to be solved.

In patent document 1, there is disclosed an image display device in which a lower electrode which constitutes an electron source is used as a signal line, an upper power supply electrode having the low sheet resistance is used as a scanning line thus setting a voltage drop which is generated in the scanning line (the scanning line electrode of the present invention) to fall within an allowable value thus suppressing the occurrence of brightness irregularities.

Further, in the conventional image display device, signal lines (signal line electrodes of the present invention) are formed on a main surface of an insulating substrate, and the scanning lines (scanning line electrodes of the present invention) are formed above the signal lines. Further, to lower the resistance of the scanning lines formed above the signal lines, there has been known the structure in which a film thickness of the scanning lines is increased. In the conventional structure which forms the scanning lines above the signal lines, there exist irregularities at a point of time that the signal lines are formed. It is difficult to form the scanning lines made of a thin film having a uniform film thickness on such irregular surface in the longitudinal direction by sputtering or the like. Further, in the conventional structure, electron sources are formed after the formation of the signal lines and before the formation of the scanning lines and hence, the formation of the scanning lines having a thick film by coating and baking of a silver paste on a signal line forming surface having electron sources is difficult to realize since the step requires a high temperature process which breaks down the electron sources.

In the related art, first of all, signal line electrodes are formed on a main surface of the insulating substrate which constitutes a first substrate and scanning line electrodes are formed above the signal line electrodes in an intersecting manner and hence, the scanning line electrodes are formed above the signal line electrodes having stepped portions. These stepped portions make the film thicknesses of the scanning line electrodes non-uniform thus giving rise to local resistance irregularities or giving rise to a possibility that a so-called broken step is generated.

Accordingly, it is an object of the present invention to provide a high-quality image display device by forming scanning line electrodes having an approximately uniform film thickness and approximately uniform low resistance over a whole length thus suppressing the local resistance irregularities and the broken step of the scanning line electrodes.

To achieve the above-mentioned object, according to the present invention, grooves are formed on a main surface of an insulation substrate or recessed portions which use an insulation film as bank portions are formed on the main surface, and scanning line lower electrodes are embedded in these grooves or recessed portions. In a state that upper surfaces of the embedded scanning line lower electrodes assume an approximately coplanar surface on the main surface of the substrate, surfaces for forming signal line electrodes which are formed above the scanning line lower electrodes are substantially leveled. The signal line electrodes are arranged above the scanning line lower electrodes by way of an insulating layer. Then, above the scanning line lower electrodes, electron sources are formed by the signal line electrodes, a tunnel insulating film and scanning line upper electrodes and hence, a width of the scanning line electrodes each of which is formed of the scanning line lower electrode and the scanning line upper electrode can be increased or a film thickness of the scanning line lower electrodes can be increased by applying and baking a paste such as a silver paste in which conductive particles are mixed whereby the resistance of the scanning line electrodes can be lowered. To exemplify constitutional features of the present invention, they are as follows.

An image display device of the present invention includes

a first substrate which includes, on a main surface of an insulating substrate, a large number of scanning line lower electrodes which extend in the first direction and are arranged in parallel in the second direction which intersects the first direction,

a large number of signal line electrodes which are arranged above the scanning line lower electrodes in an insulating manner from the scanning line lower electrodes, extend in the second direction, and are arranged in parallel in the first direction,

an electron accelerating layer which is formed above the signal line electrodes, and

scanning line upper electrodes which are formed to cover the electron accelerating layer, and are electrically connected with the scanning line lower electrodes at side portions of the signal line electrodes, wherein the first substrate includes a display region which arranges a large number of electron sources which are formed by stacking the signal line electrodes, the electron accelerating layer and the scanning line upper electrodes in a matrix array in a region where the electron accelerating layer is formed,

a second substrate which forms accelerating electrodes which accelerate electrons emitted from the electron sources and phosphors which are arranged corresponding to the respective electron sources and emit light upon excitation of the electrons form the electron sources on a main surface of a transparent insulating substrate, and

a sealing frame which, in a state that the respective main surfaces of the first substrate and the second substrate are arranged to face each other in an opposed manner, is arranged between both substrates and around the display region, and constitutes a vacuum envelope together with the first substrate and the second substrate,

wherein grooves which are dug in the main surface of the first substrate are formed in the first substrate, and the scanning line lower electrodes are embedded in the grooves. Upper surfaces of the embedded scanning line lower electrodes are substantially made coplanar on the main surface of the first substrate.

An image display device of the present invention includes a first substrate which includes, on a main surface of an insulating substrate, a large number of scanning line lower electrodes which extend in the first direction and are arranged in parallel in the second direction which intersects the first direction,

a large number of signal line electrodes which are arranged above the scanning line lower electrodes in an insulating manner from the scanning line lower electrodes, extend in the second direction, and are arranged in parallel in the first direction,

an electron accelerating layer which is formed above the signal line electrodes, and

scanning line upper electrodes which are formed to cover the electron accelerating layer, and are electrically connected with the scanning line lower electrodes at side portions of the signal line electrodes, wherein the first substrate includes a display region which arrange a large number of electron sources which are formed by stacking the signal line electrodes, the electron accelerating layer and the scanning line upper electrodes in a matrix array in a region where the electron accelerating layer is formed,

a second substrate which forms accelerating electrodes which accelerate electrons emitted from the electron sources and phosphors which are arranged corresponding to the respective electron sources and emit light upon excitation of the electrons form the electron sources on a main surface of a transparent insulating substrate, and

a sealing frame which, in a state that the respective main surfaces of the first substrate and the second substrate are arranged to face each other in an opposed manner, is arranged between both substrates and around the display region, and constitutes a vacuum envelope together with the first substrate and the second substrate,

wherein recessed portions which form bank portions using the insulation film are formed on the main surface of the first substrate, and the scanning line lower electrodes are embedded in the recessed portions. Upper surfaces of the embedded scanning line lower electrodes are substantially made coplanar on the main surface of the first substrate.

Further, in the present invention, spacers which are extended between the first substrate and the second substrate and restrict a distance between the main surfaces of the first substrate and the second substrate are provided.

In the present invention, the scanning line lower electrodes are formed of thin film lines which are patterned by etching a metal thin film made of aluminum, aluminum alloy or the like, or thick film lines which are formed by baking a silver paste.

In the present invention, a background film may be formed below the scanning line lower electrode on the main surface of the first substrate and the background film is formed of a stacked film constituted of a silicon nitride film and a silicon oxide film.

The present invention is not limited to the above-mentioned constitutions and constitutions which are disclosed in embodiments described later, and various modifications can be made without departing from the technical concept of the present invention.

According to the present invention, since the electron sources can be arranged above the scanning line lower electrodes, when the scanning line lower electrodes are formed by patterning using etching of thin films made of aluminum, aluminum alloy or the like, a line width of the electrodes can be increased thus lowering the resistance of the electrodes whereby it is possible to realize the high-quality image display device which can suppress the brightness irregularities. Further, the signal line electrodes can be formed after the formation of the scanning line lower electrodes and hence, the scanning line lower electrodes can be formed as the thick wall lines by printing and baking silver paste or the like whereby the lowering of the resistance of the scanning line lower electrodes can be realized. Further, by embedding the scanning line lower electrodes in the grooves dug into the main surface of the insulating substrate or the recessed portions which form the bank portions using the insulating layer on the main surface, it is possible to realize the lowering of the resistance of the scanning line lower electrodes while allowing the scanning line lower electrodes to have the substantially uniform film thickness. Further, the signal line electrodes which are formed above the scanning line lower electrodes can be also formed on the substantially flat surface and hence, the broken steps and the non uniform film thickness of the signal lines can be suppressed whereby the high-quality image display device can be realized in the same manner.

### BRIEF DESCRIPTION OF THE DRAWING

FIG. 1 is a plan view for schematically explaining a pixel portion for explaining an embodiment 1 of an image display device according to the present invention;

FIG. 2 is a cross-sectional view taken along a line A-A′ in FIG. 1;

FIG. 3 is a cross-sectional view similar to FIG. 2 when an insulating substrate having a background film is used;

FIG. 4 is a cross-sectional view taken along a like B-B′ in FIG. 1;

FIG. 5 is a cross-sectional view similar to FIG. 4 when an insulating substrate having a background film is used;

FIG. 6 is a cross-sectional view similar to FIG. 4 taken along a line B-B′ in FIG. 1 for explaining an embodiment 2 of an image display device according to the present invention;

FIG. 7 is a cross-sectional view similar to FIG. 4 taken along a line B-B′ in FIG. 1 for explaining an embodiment 2 of an image display device according to the present invention;

FIG. 8A, FIG. 8B, and FIG. 8C are views for explaining the more specific constitution of the embodiment 1 of the image display device of the present invention, wherein FIG. 8A is a plan view, FIG. 8B is an X-direction side view, and FIG. 8C is a Y-direction side view;

FIG. 9 is a view for explaining a manufacturing process of a first substrate explained in conjunction with the embodiment 1;

FIG. 10 is a view for explaining a manufacturing process of the first substrate explained in conjunction with the embodiment 1 which follows the manufacturing process shown in FIG. 9;

FIG. 11 is a view for explaining a manufacturing process of the first substrate explained in conjunction with the embodiment 1 which follows the manufacturing process shown in FIG. 10;

FIG. 12 is a view for explaining a manufacturing process of a first substrate explained in conjunction with the embodiment 2;

FIG. 13 is a view for explaining a manufacturing process of the first substrate explained in conjunction with the embodiment 2 which follows the manufacturing process shown in FIG. 12;

FIG. 14 is a view for explaining a manufacturing process of the first substrate explained in conjunction with the embodiment 2 which follows the manufacturing process shown in FIG. 13;

FIG. 15 is an explanatory view of a manufacturing process of a second substrate explained in conjunction with the embodiment 1 and the embodiment 2;

FIG. 16 is an explanatory view of a manufacturing process of the second substrate explained in conjunction with the embodiment 1 and the embodiment 2 which follows the manufacturing process shown in FIG. 15;

FIG. 17 is an explanatory view of a manufacturing process of the second substrate explained in conjunction with the embodiment 1 and the embodiment 2 which follows the manufacturing process shown in FIG. 16;

FIG. 18 is an explanatory view of a manufacturing process in which an image display device is formed by assembling the first substrate and the second substrate into a panel;

FIG. 19 is an explanatory view of a manufacturing process in which an image display device is formed by assembling the first substrate and the second substrate into a panel which follows the manufacturing process shown in FIG. 18;

FIG. 20 is a plan view for schematically explaining a pixel portion which explains an embodiment in which the present invention is applied to an image display device in which a signal line electrode is formed below a scanning line electrode;

FIG. 21 is a cross-sectional view taken along a line A-A′ in FIG. 20;

FIG. 22 is a cross-sectional view similar to FIG. 21 when an insulating substrate having a background film is used;

FIG. 23 is a cross-sectional view taken along a line B-B′ in FIG. 20;

FIG. 24 is a cross-sectional view similar to FIG. 23 when an insulating substrate having a background film is used;

FIG. 25 is a cross-sectional view taken along a line B-B′ in FIG. 20 for schematically explaining a pixel portion which explains another embodiment in which the present invention is applied to an image display device in which a signal line electrode is formed below a scanning line electrode; and

FIG. 26 is a cross-sectional view taken along a line B-B′ in FIG. 20 for schematically explaining a pixel portion which explains another embodiment in which the present invention is applied to an image display device in which a signal line electrode is formed below a scanning line electrode.

### DESCRIPTION OF THE PREFERRED EMBODIMENTS

Preferred embodiments of the present invention are explained in detail in conjunction with drawings which show embodiments.

### Embodiment 1

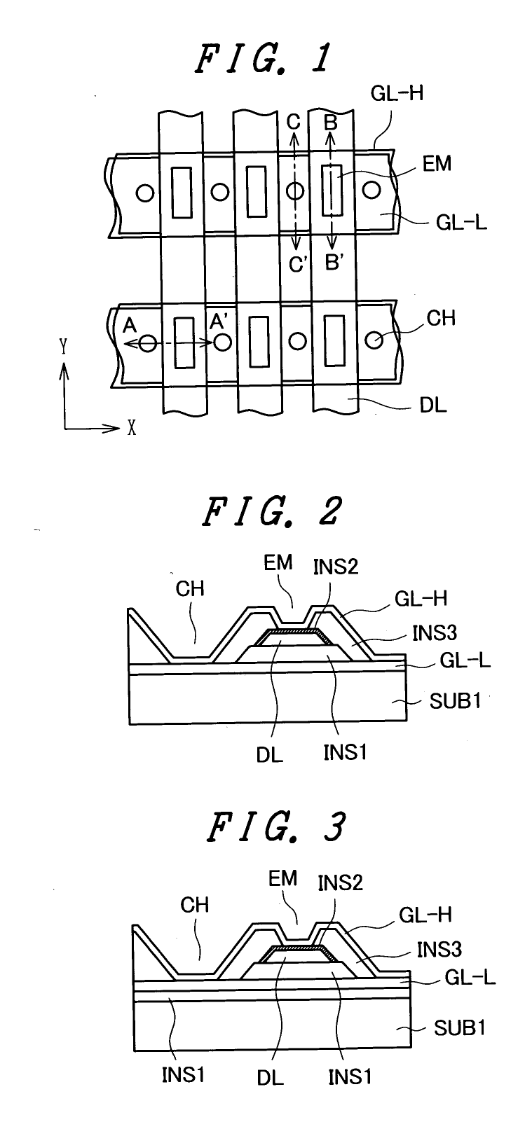

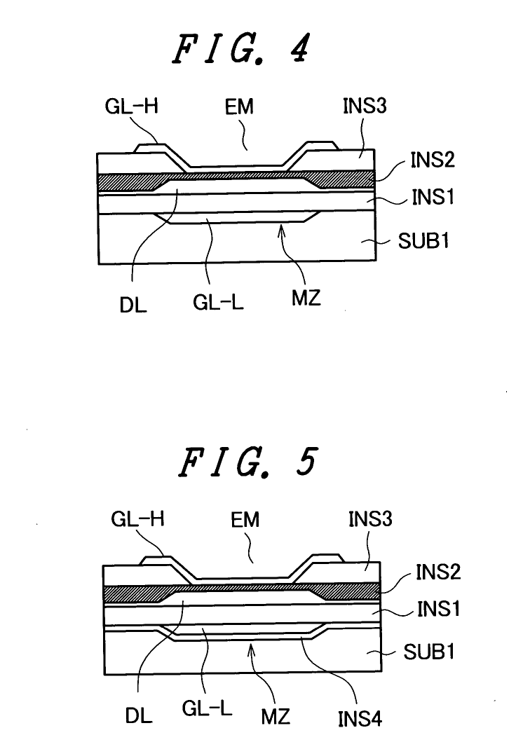

FIG. 1 is a plan view for schematically explaining a pixel portion for explaining an embodiment 1 of an image display device according to the present invention. FIG. 2 is a cross-sectional view taken along a line A-A′ in FIG. 1. Further, FIG. 3 is a cross-sectional view similar to FIG. 2 when an insulating substrate having a background film is used. Still further, FIG. 4 is a cross-sectional view taken along a like B-B′ in FIG. 1, and FIG. 5 is a cross-sectional view similar to FIG. 4 when an insulating substrate having a background film is used.

In FIG. 1 and FIG. 2, a large number of scanning line lower electrodes GL-L which constitute the scanning lines are formed on an inner surface (main surface) of an insulating substrate SUB1 which constitutes a first substrate of an image display device. In this embodiment 1, a glass substrate having no background film is used as the insulating substrate. The scanning line lower electrodes GL-L are formed by a thin film forming technique in which a thin film made of alloy of aluminum and neodymium (Al—Nd) is patterned by etching using a photo lithography technique.

A large number of scanning-line lower electrodes GL-L, as shown in FIG. 1, extend in the first direction (X direction) and are arranged in parallel in the second direction (Y direction) which intersects the first direction (here, orthogonally). Above the scanning-line lower electrodes GL-L, signal line electrodes DL which are insulated by a first insulating layer INS1 preferably made of silicon nitride are formed in an intersecting manner. The signal-line electrodes DL are made of alloy of aluminum and neodymium (Al—Nd), and a large number of signal line electrodes DL extend in the Y direction and are arranged in parallel in the X direction.

A scanning line upper electrode GL-H is formed with respect to the signal line electrode DL by interposing a second insulating layer INS2 in a region which constitutes a tunnel insulating film forming an electron accelerating layer of an electron source EM and interposing a third insulating layer INS3 in other regions. The second insulating layer INS2 may be formed by anodizing a surface of the signal line electrode DL. The scanning line upper electrode GL-H is preferably made of precious metal such as iridium (Ir), platinum (Pt), Gold (Au) or the like. As shown in FIG. 2, the scanning line upper electrode GL-H is electrically connected with the scanning-line lower electrode GL-L via a contact hole CH which penetrates the third insulating layer INS3 and hence, the scanning line is constituted of the scanning-line lower electrode GL-L and the scanning line upper electrode GL-H.

The electron source EM is constituted of a stacked portion of the signal line electrode DL, the second insulating layer INS2 and the scanning line upper electrodes GL-H. The second insulating layer INS2 is formed with a thickness smaller than a thickness of the third insulating layer INS3 and is also referred to as an electron accelerating layer or the tunnel insulating film. As shown in FIG. 1, the electron source EM is, as viewed in a plan view, positioned above the signal line electrode DL in a region of the scanning line lower electrode GL-L. Accordingly, the scanning line lower electrode GL-L can be formed with a large width to an extent that the scanning line lower electrode GL-L is not brought into contact with the neighboring scanning line lower electrode GL-L thus realizing the lowering of the resistance thereof. Here, the scanning line upper electrode GL-H may be formed with a width substantially equal to the width of the scanning line lower electrode GL-L. Here, a case in which the insulating substrate having a background film is used is shown in FIG. 3.

A cross section of the electron source EM portion along a line B-B′ in FIG. 1 exhibits, as shown in FIG. 4, the stacked structure which is constituted of the scanning line lower electrode GL-L which is embedded in a groove MZ formed in a main surface of the insulating substrate SUB1 which constitutes the first substrate, the first insulating layer INS1, the signal line electrode DL, the second insulating layer INS2, the third insulating layer INS3, and the scanning line upper electrode GL-H. Further, the electron source EM is constituted of the signal line electrode DL, the second insulating layer INS2 (the electron accelerating layer) and the scanning line upper electrode GL-H. Further, when a glass substrate having a background film INS4 is used, the cross section of the electron source EM portion exhibits a cross section shown in FIG. 5. As shown in FIG. 5, the background film INS4 is present also on a bottom portion of the groove MZ and in the vicinity of the bottom portion (inclined surfaces of the groove) and hence, the background film INS4 is interposed between the scanning-line lower electrodes GL-L and the glass substrate SUB1. However, it may be possible to adopt the structure in which the background film INS4 is not formed on the bottom portion of the groove MZ and in the vicinity of the bottom portion.

According to the embodiment 1, it is possible to form the scanning line lower electrodes which realize the uniform film thickness and the uniform lowering of the resistance, wherein surfaces of the scanning line lower electrodes are made approximately flat on the main surface of the insulating substrate. Accordingly, even when a panel becomes large sized, the brightness irregularities attributed to the increase of a distance from a power supply end of the scanning line can be suppressed and the signal line electrodes can be also formed on a substantially flat surface whereby it is possible to realize a high-quality image display device which can suppress broken steps and a non-uniform film thickness.

### Embodiment 2

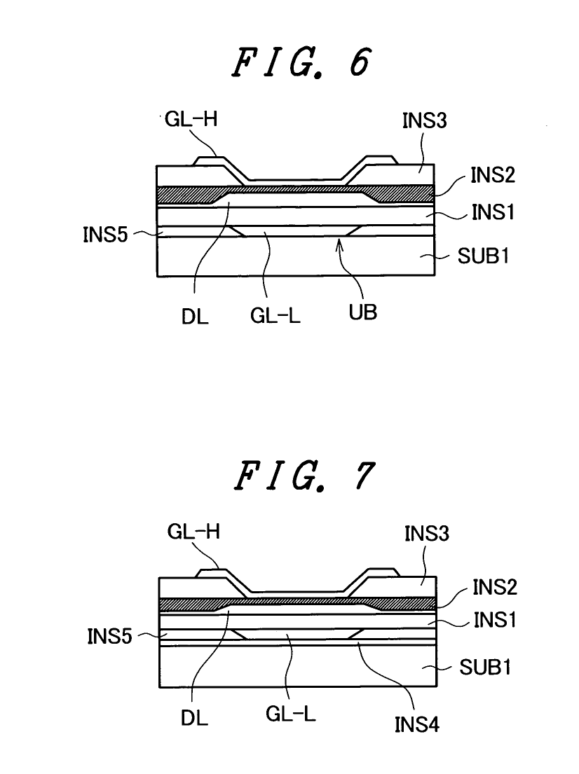

FIG. 6 is a cross-sectional view similar to FIG. 4 taken along a line B-B′ in FIG. 1 for explaining an embodiment 2 of an image display device according to the present invention. In the embodiment 2 shown in FIG. 6, a recessed portion UB is formed by removing an insulating layer INS5 in a groove shape using the insulating layer INS5 as a bank portion on a main surface of a glass substrate SUB1, and a scanning line lower electrode GL-L is embedded in the recessed portion UB. On the main surface of the glass substrate SUB1, a surface of the scanning line lower electrode GL-L and a surface of the insulating layer INS5 are made substantially coplanar with each other. An insulating layer INS1 is formed on the scanning line lower electrode GL-L and the insulating layer INS5 and, thereafter, a signal line electrode DL is formed. Thereafter, the stacked structure similar to the stacked structure of the embodiment 1 is formed. Further, when a glass substrate using a background film INS4 is used, the stacked structure shown in FIG. 7 is obtained. In FIG. 7, the background film INS4 is interposed between the scanning line lower electrode GL-L and the glass substrate SUB1 in a state that the background film INS4 is present on a bottom portion of the recessed portion UB as well as in the vicinity of the bottom portion. However, it may be possible to adopt the structure in which the background film INS4 is not provided to the bottom portion of the recessed portion UB and the vicinity of the bottom portion.

According to the embodiment 2, it is possible to form the scanning line lower electrodes which realize the uniform film thickness and the uniform lowering of the resistance, wherein surfaces of the scanning line lower electrodes are made approximately flat on the main surface of the insulating substrate. Accordingly, even when a panel becomes large sized, the brightness irregularities attributed to the increase of a distance from a power supply end of the scanning line can be suppressed and the signal line electrodes can be also formed on a substantially flat surface whereby it is possible to realize a high-quality image display device which can suppress broken lines and a non-uniform steps thickness.

The background layer in the embodiment 1 and the embodiment 2 is preferably made of silicon nitride SiN or silicon oxide SiO. By providing such a background layer, it is possible to prevent sodium ions (Na⁺) and potassium ions (K⁺) from the glass substrate from being refused to the scanning line lower electrode GL-L side and the signal line electrode DL side thus suppressing the deterioration of electrodes attributed to these ions.

Further, a paste in which conductive particles made of silver or the like are mixed is applied to the scanning line lower electrode GL-L by screen printing or the like and the paste is baked so as to form the scanning line lower electrode having a large film thickness. Accordingly, it is possible to realize the scanning line lower electrode GL-L having the low resistance.

Particularly, in the embodiment 2 which forms the scanning line lower electrode GL-L as an electrode having a large film thickness by coating and baking the silver paste or the like, it is not always necessary that the main surface of the glass substrate is flattened.

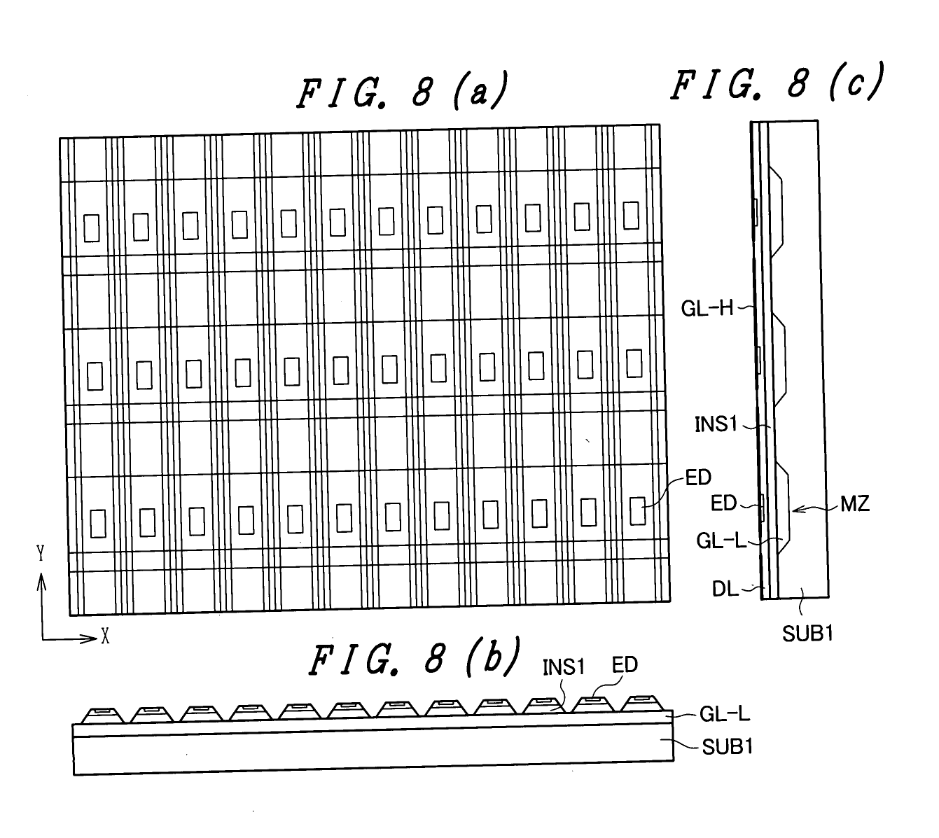

FIG. 8A, FIG. 8B, and FIG. 8C are views for explaining the specific constitution of the embodiment 1 of the image display device of the present invention, wherein FIG. 8A is a plan view, FIG. 8B is an X-direction side view, and FIG. 8C is a Y-direction side view. Although FIG. 8A, FIG. 8B and FIG. 8C show a type of image display device which is not provided with a background layer on a main surface of the glass substrate SUB1 which constitutes an insulating substrate of the first substrate, the image display device having a background layer also has the constitution similar to the constitution shown in FIG. 8A to FIG. 8C except for the background layer.

In FIG. 8A, FIG. 8B and FIG. 8C, the scanning line lower electrodes GL-L are formed on the main surface of the glass substrate SUB1. The scanning line lower electrodes GL-L are formed by applying the silver paste to the grooves MZ formed in the main surface of the glass substrate SUB1 explained in conjunction with the embodiment 1 and by baking the silver paste. After applying and baking the silver paste, the insulating layer INS1, the signal line electrodes DL, the scanning line upper electrodes GL-H and the like are formed thus obtaining the image display device which arranges the electron sources ED on portions where the signal line electrodes DL and the scanning line lower electrodes GL-L intersect with each other. The electron source ED is constituted in a state that the signal line electrode DL forms a lower electrode and the scanning line upper electrode GL-H which covers an upper layer of the tunnel insulation film formed on an upper surface of the signal line electrode DL and is connected to the scanning line lower electrode GL-L forms an upper electrode. Here, in FIG. 8, the respective insulating layers and insulation films other than the insulating layer INS1 shown in the above-mentioned embodiment 1 are omitted from the drawing.

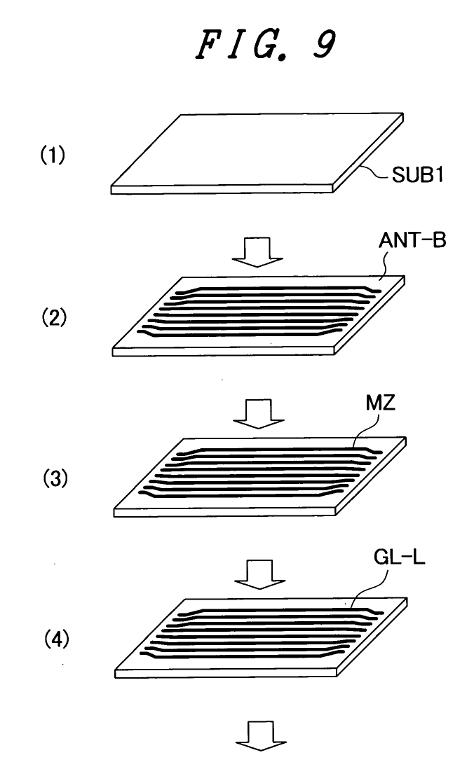

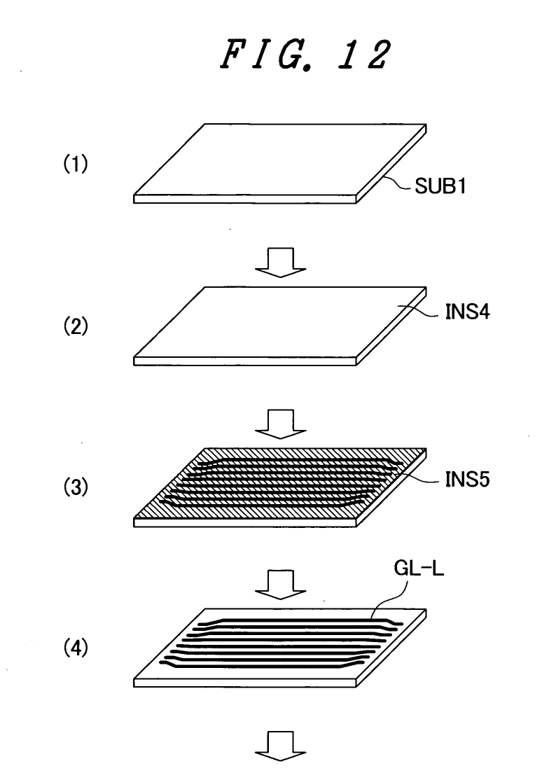

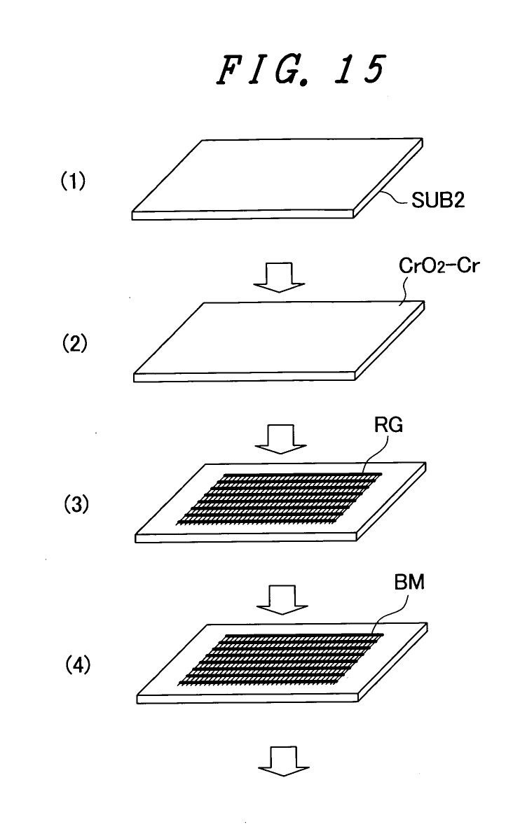

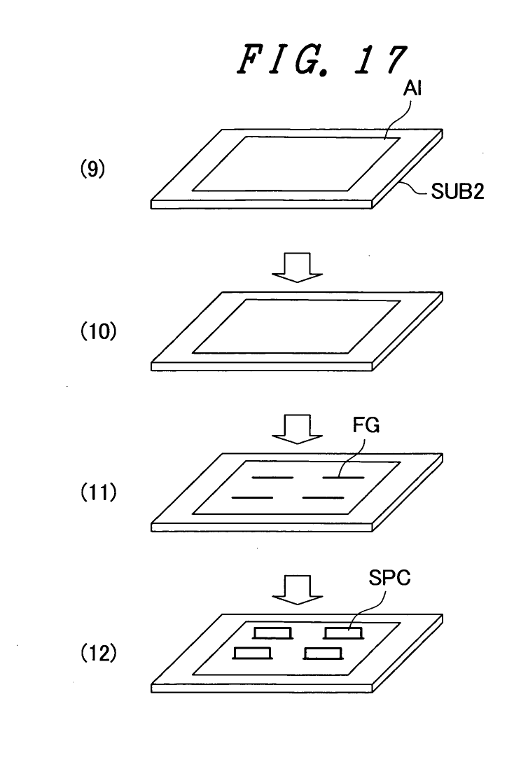

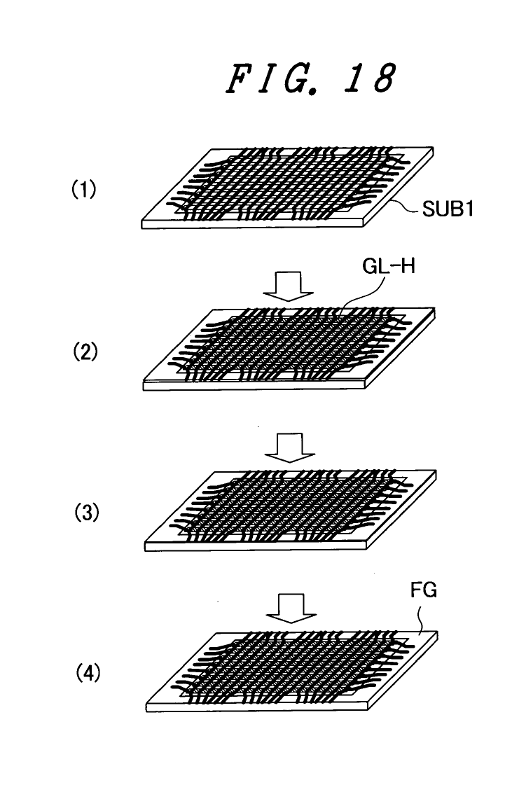

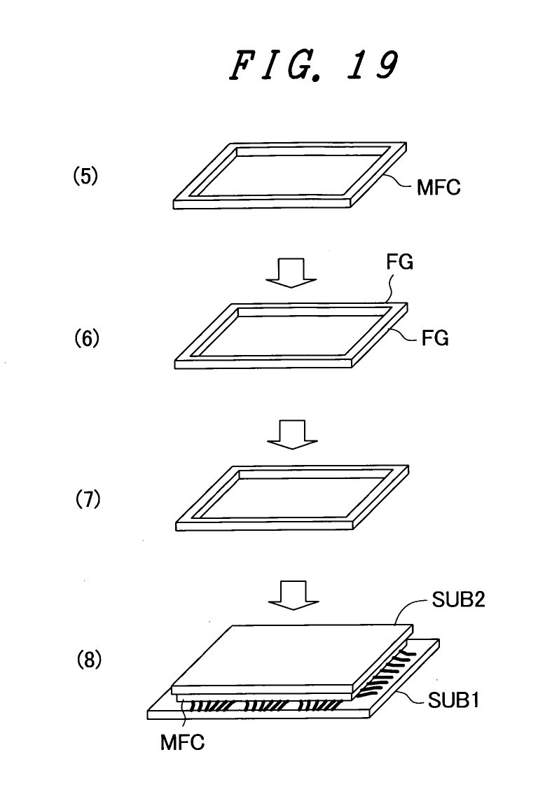

Next, the whole manufacturing process of the image display device according to the present invention is explained in conjunction with FIG. 9 to FIG. 19. FIG. 9 to FIG. 11 are explanatory views of the manufacturing process of the first substrate are explained in conjunction with the embodiment 1, and FIG. 12 to FIG. 14 are explanatory views of the manufacturing process of the first substrate explained in conjunction with the embodiment 2. Further, FIG. 15 to FIG. 17 are explanatory views of the manufacturing process of the second substrate explained in conjunction with the embodiment 1 and the embodiment 2. Still further, FIG. 18 and FIG. 19 are explanatory views of the manufacturing process in which the first substrate and the second substrate assembled into a panel thus forming the image display device. Here, although the explanation is made with respect to a case in which the glass substrate having no background layer is used in the process described hereinafter, the substantially same manufacturing process is adopted even when a case in which the glass substrate having the background layer is used.

The manufacturing process of the first substrate is explained in conjunction with FIG. 9 to FIG. 11. Here, sand blast forming is applied to the main surface of the glass substrate which constitutes the first substrate thus forming grooves on the main surface of the glass substrate. However, the formation of the grooves is not limited to the sand blasting and the grooves may be formed by etching using hydrofluoric acid or other glass surface forming technique applied to a base substrate.

In FIG. 9, the glass substrate SUB1 is cleaned with pure water, and is baked to remove strains (1). After cleaning, a blast-resistant resist ANT-B is printed on the glass substrate SUB1 in a pattern which excludes portions corresponding to the grooves to be formed using a screen printing machine, and the glass substrate SUB1 is heated at a temperature of approximately 80° C. in the inside of a drying furnace so as to remove a solvent in the inside of the resist (2). As a typical example of the film thickness of the resist ANT-B, the film thickness is set to 10 μm, for example. Shaving is applied to the glass substrate SUB1 on which the pattern of the resist ANT-B is formed using a sand blast device thus forming the grooves MZ. A depth of the grooves MZ is set to approximately 15 μm, for example. Thereafter, the resist ANT-B is peeled off and removed (3). In peeling off the resist ANT-B, the resist ANT-B is swelled with a 3 weight % sodium hydroxide aqueous solution and is cleaned and removed. After the removal of the resist ANT-B, the glass substrate SUB1 is dried. Here, it is also possible to adopt a method in which a blast-resistant photosensitive resist is applied to the glass substrate SUB1 and is dried, and the photosensitive resist is allowed to remain at portions excluding portions corresponding to the grooves to be formed using a photo lithography technique.

Using the screen printing machine, the silver paste is printed in a state that the silver paste is filled and embedded in the formed grooves MZ, and is baked in a baking furnace at a temperature of approximately 500° C. to remove binders thus forming the scanning line lower electrodes GL-L (4). Then, polishing is performed so as to prevent the generation of stepped portions between the scanning line lower electrodes GL-L and the main surface of the glass substrate SUB1.

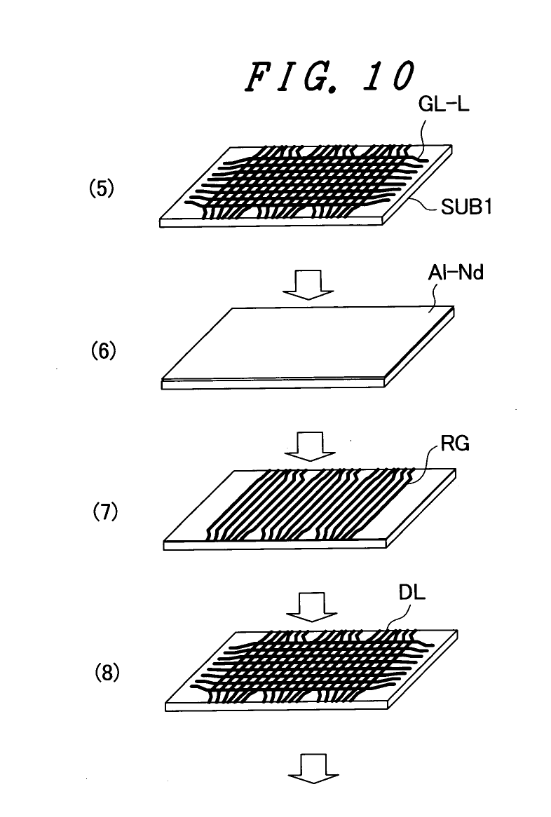

In FIG. 10, using the screen printing machine, a dielectric glass paste is printed on the glass substrate SUB1 in a desired pattern in the direction orthogonal to the scanning line lower electrodes GL-L. The dielectric glass paste is baked by heating at a temperature of approximately 500° C. in a baking furnace thus forming the insulating layer INS1 (5). On the whole surface of the insulating layer INS1, using a sputtering device, an Al—Nd (Al+2 wt % Nd) film having a film thickness of 400 nm is formed (6).

On the Al—Nd film, etching resists RG having a thickness of 10 μm are formed in a pattern of the signal line electrodes which are orthogonal to the scanning line lower electrodes, and the etching resists RG are heated at a temperature of approximately 80° C. in the inside of a drying furnace thus removing a solvent in the inside of the etching resists RG (7). In an etching device, a mixed liquid of phosphoric acid and nitric acid is used as an etchant thus forming the signal line electrodes DL formed of the Al—Nd film. In a peeling device, the etching resists are dissolved and removed using a peeling liquid and are cleaned (8).

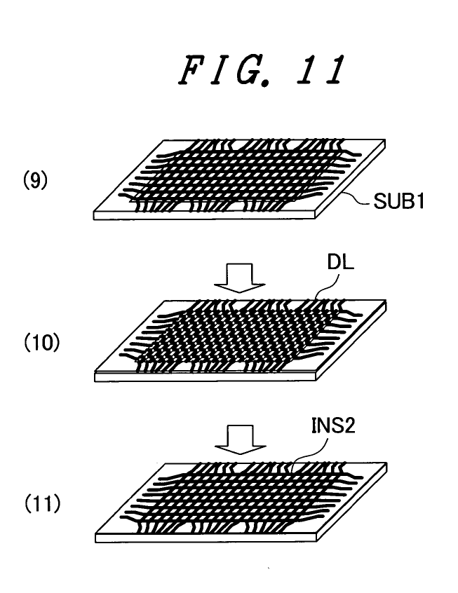

In FIG. 11, on the signal line electrodes which are formed by etching, using a DC reactive sputtering device, an oxynitriding silicon SiON film having a film thickness of 200 nm is formed as an insulating layer. A dry film which forms a resist is laminated using a laminator. Predetermined portions are exposed using a laser direct drawing device. These portions are exposed and the resist other than the exposed portions is removed (9). The insulating layer SiON other than the resist pattern portions is removed by a dry etching device. Then, in a peeling device, the etching resists are dissolved and removed (10).

Using a chemical liquid in an anodizing device, an anodized film AL₂O₃ having a film thickness of approximately 10 nm is formed thus obtaining the tunnel insulating film INS2 (11). The tunnel insulating film INS2 is cleaned and dried. Hereinafter, an Ir/Pt/Au film is formed using a sputtering device thus forming the scanning line upper electrodes GL-H. The scanning-line upper electrodes GL-H are as shown in FIG. 1 and FIG. 2, electrically connected with the scanning line lower electrodes GL-L byway of contact holes CH. Then, the scanning line upper electrodes are separated for every scanning line using a laser device.

Next, the manufacturing process of the first substrate explained in conjunction with the embodiment 2 is explained in conjunction with FIG. 12 to FIG. 14. Here, on the main surface of the glass substrate, a recessed portion which forms bank portions using the insulating film is formed, and the scanning line lower electrode is embedded in the recessed portion. First of all, in FIG. 12, the glass substrate SUB1 which constitutes the first substrate is cleaned and is baked to remove strains (1). An SiO₂ film is formed on the main surface as the insulating layer INS4 (2). A glass paste is applied to the glass substrate SUB1 by screen printing thus forming the insulating layer INS5 which constitutes bank portions of the recessed portions (3). A silver paste is printed by screen printing such that the silver paste is embedded in the recessed portions and is baked to form the scanning line lower electrodes GL-L (4).

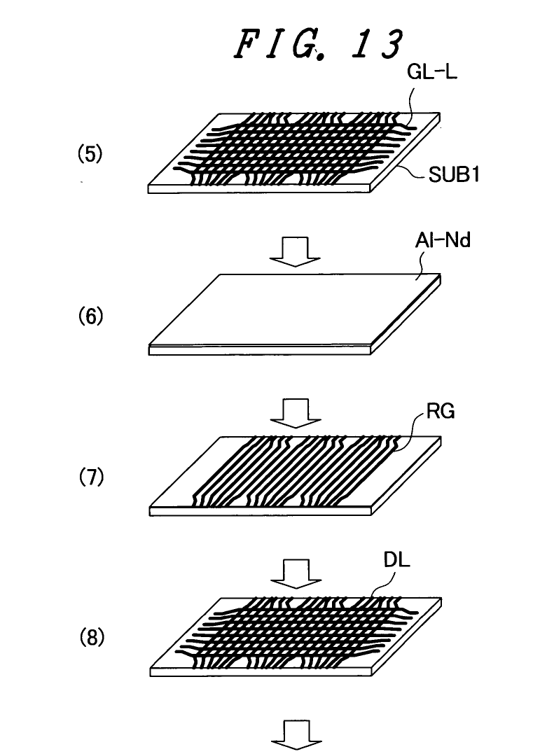

In FIG. 13, a glass paste is printed by screen printing and is baked to form the insulating layer INS1 (5). Al—Nd is sputtered onto the insulating layer INS1 (6), and an etching resist is printed in a pattern of signal line electrodes (7). The signal line electrodes DL are formed by etching, and the resist is removed, and the signal line electrodes DL are cleaned (8).

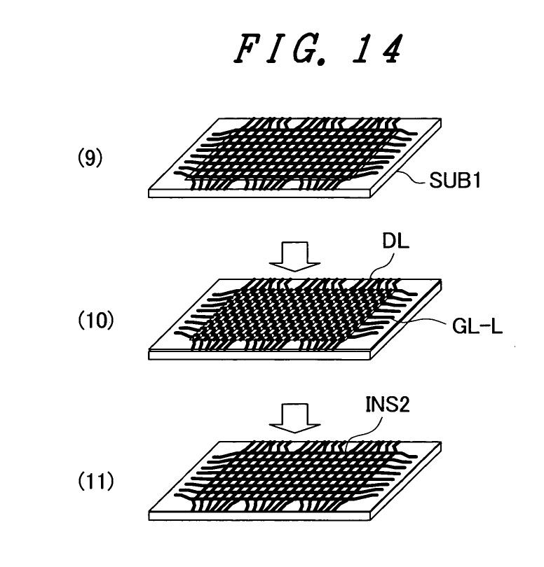

In FIG. 14, the insulating layer INS3 is applied to the glass substrate SUB1 to cover the signal line electrodes DL, a resist is applied to the insulating layer INS3. After the resist is dried, the exposure and the developing are performed so as to form openings in electron-source forming portions of the signal line electrodes DL (9). The resist is peeled off and the signal-line electrodes DL are cleaned (10). The anodization is applied to the signal line electrodes DL exposed through the opening portions of the insulating layer INS3 thus forming tunnel insulating films INS2 (11). Hereinafter, an Ir/Pt/Au film is formed by a sputtering device to form the scanning line upper electrodes GL-H. The scanning line upper electrodes GL-H are, as shown in FIG. 1 and FIG. 2, electrically connected with the scanning line lower electrodes GL-L via contact holes CH. Further, the scanning line upper electrodes GL-H are separated for every scanning line using a laser device.

The manufacturing process of the second substrate is explained in conjunction with FIG. 15 to FIG. 17. First of all, in FIG. 15, the glass substrate SUB2 which constitutes the second substrate is cleaned and is baked for removing strains (1). For forming a film for black matrix, CrO₂—Cr is sputtered (2). A photoresist RG is applied to the film for black matrix. After the photoresist RG is dried, using a mask having a pattern of the black matrix, the photoresist RG is exposed and developed (3) and the black matrix BM is formed by etching. The resist is removed and the black matrix BM is cleaned (4).

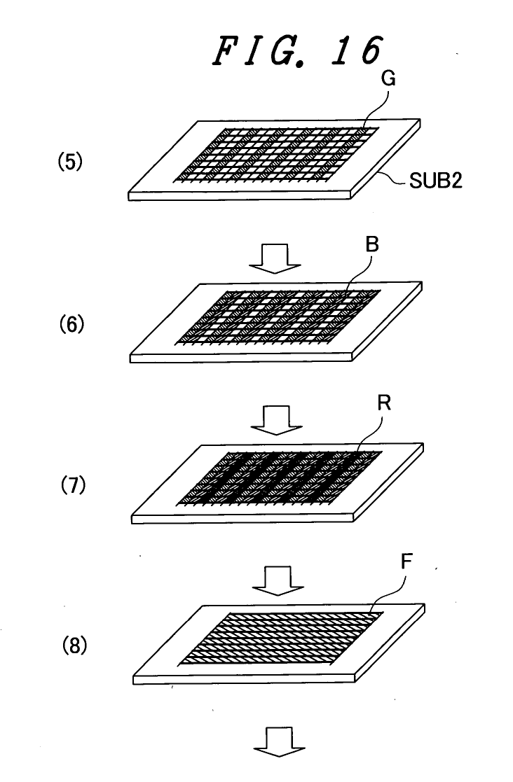

In FIG. 16, green phosphors (G) are printed in the green (G) openings of the formed black matrix BM and are dried (5). Next, blue phosphors (B) are printed in the blue (B) openings of the black matrix BM and are dried (6). Then, red phosphors (R) are printed in the red (R) openings of the black matrix BM and are dried (7). Finally, a protective leveled film F is applied to cover a phosphor screen which is constituted of the black matrix BM and three-color phosphors (G), (B), and (R) (8).

In FIG. 17, an aluminum film which constitutes an anode (an accelerating electrode) AD is formed as a film on the protective leveled film F (9). Binders made of organic substances which are contained in the respective phosphors and the leveling film formed in FIG. 16 are removed (10), frit glass FG is applied to predetermined positions using a dispenser (11), spacers SPC are mounted in an erected manner, and binders formed of organic substances which are contained in the frit glass are removed (12).

Next, a process for assembling the first substrate and the second substrate is explained in conjunction with FIG. 18 and FIG. 19. First of all, in FIG. 18, the first substrate (so-called the cathode substrate) SUB1 is subjected to dry cleaning (1), also explained in conjunction with FIG. 14, any one of Gold (Au), Platinum (Pt) and an Iridium (Ir) or an alloy film of these metals which form the scanning line upper electrodes GL-H is sputtered to cover the main surface of the cleaned first substrate SUB1 (2). The scanning line upper electrodes GL-H which are formed by sputtering are separated along boundaries of the scanning line lower electrodes GL-L by a laser (3). Frit glass FG is applied to a position where a sealing frame is mounted (4).

In FIG. 19, a sealing frame (frame glass) MFC is prepared and is cleaned (5). The frit glass FG is applied to both surfaces of the cleaned sealing frame MFC using a dispenser (6). Binders formed of organic substances which are contained in the frit glass FG are removed (7). The sealing frame MFC is placed on the first substrate SUB1 and the second substrate SUB2 is overlapped to the sealing frame MFC and the stacked structure is heated, the frit glass FG is melted so as to adhere the first substrate SUB1, the sealing frame MFC and the second substrate SUB2 to each other, and the inside defined by these members is evacuated into a vacuum and is sealed (8). In this manner, the image display device is assembled.

The above-mentioned explanation is made on the premise that the scanning line lower electrodes GL-L constitute the lower layer and the signal line electrodes DL are stacked on the scanning line lower electrodes GL-L in a state that the signal line electrodes DL intersect the scanning line lower electrodes GL-L. However, the present invention is applicable to the structure in which the signal line electrodes DL constitute the lower layer as in the case of the conventional structure.

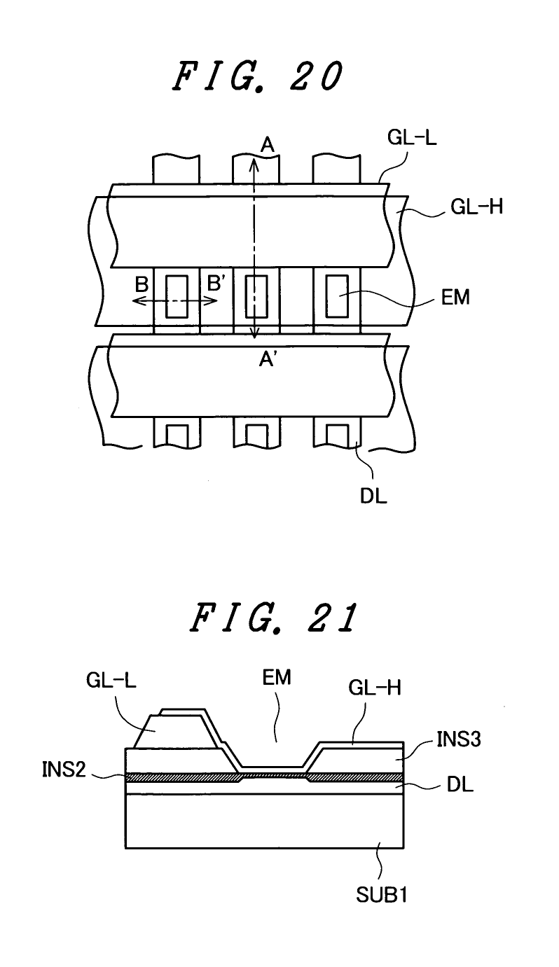

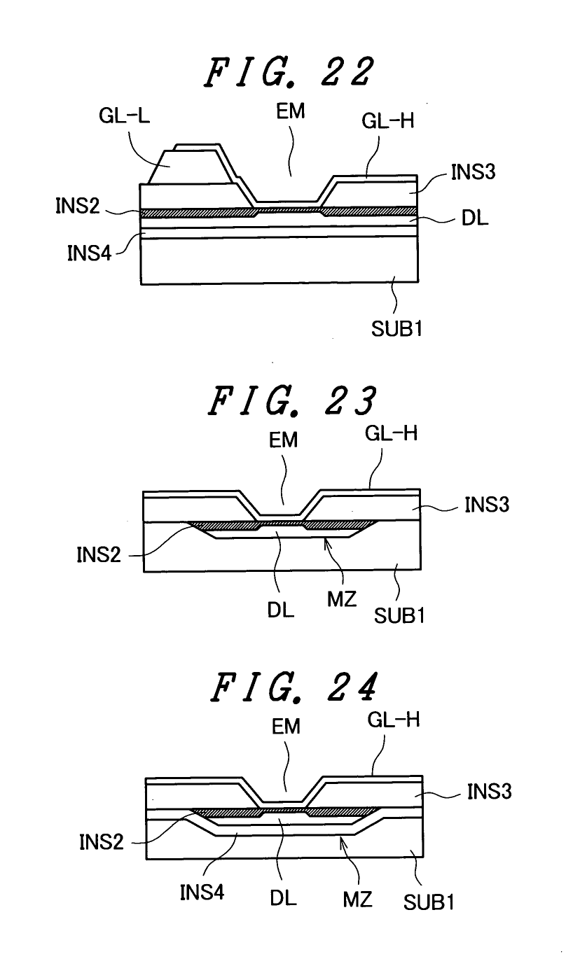

FIG. 20 is a plan view for schematically explaining a pixel portion which explains an embodiment in which the present invention is applied to an image display device in which a signal line electrode is formed below a scanning line electrode. FIG. 21 is a cross-sectional view taken along a line A-A′ in FIG. 20. FIG. 22 is a cross-sectional view similar to FIG. 21 when an insulating substrate having a background film is used. Further, FIG. 23 is a cross-sectional view taken along a line B-B′ in FIG. 20, and FIG. 24 is a cross-sectional view similar to FIG. 23 when an insulating substrate having a background film is used.

As shown in FIG. 20, FIG. 21 and FIG. 22, signal line electrodes DL are formed on an inner surface (a main surface) of an insulating substrate SUB1 which constitutes a first substrate of the image display device. As shown in FIG. 23 and FIG. 24, the signal line electrodes DL are embeddeding grooves MZ formed in the main surface of the insulating substrate SUB1. Here, FIG. 22 and FIG. 24 are substantially equal to FIG. 21 and FIG. 23 except for a point that the structure shown in FIG. 22 and FIG. 24 has an insulating layer INS4 which constitutes the background film and hence, the constitution other than the insulating layer INS4 is explained in conjunction with FIG. 21 and FIG. 23.

An insulating layer INS2 is formed on the signal line electrodes DL and an insulating layer INS3 is formed on the insulating layer INS2. Electron source forming portions of the insulating layers INS2, INS3 are etched so as to expose the signal line electrodes DL. Surfaces of the exposed signal line electrodes DL are anodized to form tunnel insulating films. Then, scanning line lower electrodes GL-L are formed on the insulating layer INS3 on one sides of the electron sources and, thereafter, scanning line upper electrodes GL-H are formed in a state that the scanning line upper electrodes GL-H cover the scanning line lower electrodes GL-L, the tunnel insulating films, and the insulating layer INS3. The scanning line lower electrodes GL-L constitute bus electrodes of scanning lines and realize the lowering of resistance of the bus electrodes. An electron source EM is constituted as the stacked structure formed of the signal line electrode DL and the scanning line upper electrode GL-H which sandwich the tunnel insulating film therebetween.

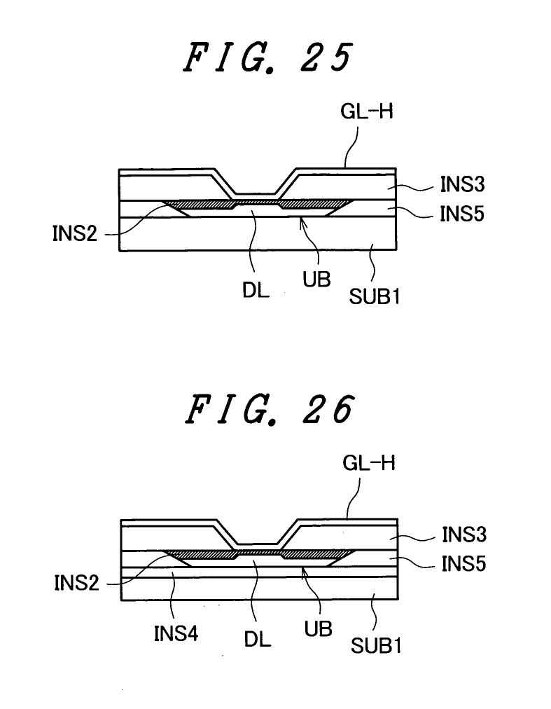

FIG. 25 and FIG. 26 are cross-sectional views taken along a line B-B′ in FIG. 20 for schematically explaining a pixel portion which explains another embodiment in which the present invention is applied to an image display device in which a signal line electrode is formed below a scanning line electrode. Here, FIG. 26 is substantially equal to FIG. 25 except for a point that a background film is formed on a main surface of an insulating substrate SUB1 and hence, the explanation is made in conjunction with FIG. 25. In this embodiment, an insulating layer INS5 is formed on the main surface of the insulating substrate SUB1, and signal line electrodes are embedded in recessed portions UB which form bank portions using insulating layers INS5. Other constitutions are substantially equal to the corresponding constitutions of the previous embodiments.

Also with these constitutions, it is possible to form the scanning line lower electrodes which realize the uniform film thickness and the uniform lowering of the resistance above the signal line electrodes and hence, the resistance of the scanning line lower electrodes can be lowered and, even when the panel becomes large-sized, the brightness irregularities attributed to the increase of distance from the power supply end of the scanning line can be suppressed thus realizing the high-quality image display device.

What is claimed is:

1. An image display device comprising:
a first substrate which includes, on a main surface of an insulating substrate, a large number of scanning line lower electrodes which extend in the first direction and are arranged in parallel in the second direction which intersects the first direction,
a large number of signal line electrodes which are arranged above the scanning line lower electrodes in an insulating manner from the scanning line lower electrodes, extend in the second direction, and are arranged in parallel in the first direction,
an electron accelerating layer which is formed above the signal line electrodes, and
scanning line upper electrodes which are formed to cover the electron accelerating layer, and are electrically connected with the scanning line lower electrodes at side portions of the signal line electrodes, wherein the first substrate further includes a display region which arranges a large number of electron sources which are formed by stacking the signal line electrodes, the electron accelerating layer and the scanning line upper electrodes in a matrix array in a region where the electron accelerating layer is formed;
a second substrate which forms an accelerating electrodes which accelerate electrons emitted from the electron sources and phosphors which are arranged corresponding to the respective electron sources and emit light upon excitation of the electrons form the electron sources on a main surface of a transparent insulating substrate; and
a sealing frame which, in a state that the respective main surfaces of the first substrate and the second substrate are arranged to face each other in an opposed manner, is arranged between both substrates and around the display region, and constitutes a vacuum envelope together with the first substrate and the second substrate, wherein
grooves which are dug in the main surface of the first substrate are formed in the first substrate, and the scanning line lower electrodes are embedded in the grooves.

2. An image display device according to claim 1, wherein a background film is formed on a main surface of the first substrate.

3. An image display device according to claim 2, wherein the background film is also formed between a bottom surface of the groove and the scanning line lower electrode.

4. An image display device comprising:
a first substrate which includes, on a main surface of an insulating substrate, a large number of scanning line lower electrodes which extend in the first direction and are arranged in parallel in the second direction which intersects the first direction,
a large number of signal line electrodes which are arranged above the scanning line lower electrodes in an insulating manner from the scanning line lower electrodes, extend in the second direction, and are arranged in parallel in the first direction,
an electron accelerating layer which is formed above the signal line electrodes, and
scanning line upper electrodes which are formed to cover the electron accelerating layer, and are electrically connected with the scanning line lower electrodes at side portions of the signal line electrodes, wherein the first substrate further includes a display region which arranges a large number of electron sources which are formed by stacking the signal line electrodes, the electron accelerating layer and the scanning line upper electrodes in a matrix array in a region where the electron accelerating layer is formed;
a second substrate which forms an accelerating electrodes which accelerate electrons emitted from the electron sources and phosphors which are arranged corresponding to the respective electron sources and emit light upon excitation of the electrons form the electron sources on a main surface of
a transparent insulating substrate; and
a sealing frame which, in a state that the respective main surfaces of the first substrate and the second substrate are arranged to face each other in an opposed manner, is arranged between both substrates and around the display region, and constitutes a vacuum envelope together with the first substrate and the second substrate, wherein
recessed portions which form bank portions using the insulating film are formed on the main surface of the first substrate, and the scanning line lower electrodes are embedded in the recessed portions.

5. An image display device according to claim 4, wherein a background film is formed on a main surface of the first substrate.

6. An image display device according to claim 4, wherein spacers which are extended between the first substrate and the second substrate and restrict a distance between the main surfaces of the first substrate and the second substrate are provided.

7. An image display device according to claim 4, wherein the scanning line lower electrodes are formed of thin film lines which are patterned by etching a metal thin film made of aluminum, aluminum alloy.

8. An image display device according to claim 4, wherein the scanning line lower electrodes are formed by baking
a silver paste and have a large film thickness.

9. An image display device according to claim 4, wherein a background film is formed below the scanning line lower electrode on the main surface of the first substrate.

10. An image display device according to claim 4, wherein the background film is formed of a stacked film constituted of a silicon nitride film and a silicon oxide film.
